(19) United States
(12) Patent Application Publication
(10) Pub. No.: US 2015/0235482 A1
(43) Pub. Date: Aug. 20, 2015

(54) Method for providing data associated with a vehicle

(71) Applicant: CONTINETAL AUTOMOTIVE GMBH, Hannover (DE)

(72) Inventor: Patrik Helbig, Sulz am Neckar (DE)

(21) Appl. No.: 14/428,878

(22) PCT Filed: Sep. 13, 2013
(86) PCT No.: PCT/EP2013/069050

§ 371 Date: Mar. 17, 2015

(30) Foreign Application Priority Data
Sep. 18, 2012 (DE) 10 2012 216 666.1

(51) Int. Cl. G07C 5/00; G01C 21/36

(52) U.S. Cl. CPC G07C 5/008; G01C 21/3688

(57) ABSTRACT

A method for providing data associated with a vehicle having a vehicle unit includes: the vehicle unit determining first data that characterizes a state of the vehicle; determining, by a sensor device of a portable multifunction device, second data; coupling the portable multifunction device to the vehicle; transmitting the first data to the portable multifunction device; and storing the first and second data in the storage device of the portable multifunction device.

### CROSS-REFERENCE TO RELATED APPLICATIONS

This is a U.S. national stage of application No. PCT/EP2013/069050, filed on 13 Sep. 2013, which claims priority to the German Application No. DE 10 2012 216 666.1 filed September 2012, the content of both incorporated herein by reference.

### BACKGROUND OF THE INVENTION

1. Field of the Invention

The present invention relates to a method for providing data associated with a vehicle, for example data that characterizes a state of the vehicle and data that indicates a position of the vehicle. The invention also relates to a readable storage medium for storing at least one program comprising instructions for carrying out a method for providing data associated with a vehicle. The invention also relates to a portable multifunction device, in particular a smartphone, and to a vehicle.

2. Related Art

In order to make it possible to locate a vehicle or in order to record a route of a vehicle, permanently installed and on-board computers (OBC) may be provided in the vehicle and are connected to the electronics of the vehicle. Such an on-board computer records position data relating to the vehicle, for example according to a predefined algorithm, and transmits the data to a central server. Since the on-board computer is permanently associated with a particular vehicle, the central server can access the transmitted data and can make statements on the route. However, an on-board computer in the vehicle for providing position data requires an increased space requirement. Furthermore, an additional amount of effort is needed to cable the on-board computer to the electronics of the vehicle.

### SUMMARY OF THE INVENTION

It is therefore an object of the invention to specify a method for providing data associated with a vehicle, in which the provision of additional components, in particular an on-board computer for providing position data relating to the vehicle, is dispensed with and therefore there is no need to keep installation space for such components. The intention is also to specify a readable storage medium having a program for carrying out the method. The intention is also to specify a portable multifunction device, in particular a smartphone, and a vehicle that can be used to carry out the method. In addition, the intention is to specify a system for providing data associated with a vehicle.

According to one embodiment, a method for providing data associated with a vehicle comprises the following steps of:
providing the vehicle having a vehicle unit for determining first data for characterizing a state of the vehicle,
providing a portable multifunction device having a sensor device for determining second data and a storage device for storing the first and second data,
coupling the portable multifunction device to the vehicle,
determining the first data using the vehicle unit,
determining the second data using the sensor device of the portable multifunction device,
transmitting the first data to the portable multifunction device,
storing the first and second data in the storage device of the portable multifunction device.

According to one embodiment of the method, a smartphone can be used as the portable multifunction device. Such a smartphone provides many possible ways of contacting drivers on account of its communication and locating functions. However, since a conventional smartphone is mobile, it is initially not possible to draw a conclusion as to a vehicle from which the first data has been transmitted to the smartphone. If, after evaluation of the data recorded in the portable multifunction device, a slow continued movement results, it is not possible to determine, for example, whether the smartphone is in the vehicle and the vehicle is currently in a traffic jam, or whether the driver is carrying the smartphone outside the vehicle.

An aspect of the invention provides for a driver to be able to connect to a vehicle using the portable multifunction device. The driver can use a radio interface for example, in particular a WLAN interface or a Bluetooth interface, to connect the portable multifunction device to a digital tachograph in the vehicle or, if the latter is not available, to an OBD (on-board diagnosis) connector with a radio interface.

In the case of a smartphone, an application (a so-called app) on the smartphone can verify that the smartphone is connected to a specific vehicle as long as the radio path exists. This can be carried out, for example, by reading a VIN (Vehicle Identification Number) and/or a VRN (Vehicle Registration Number). If the first data is vehicle data, the position data determined in the portable multifunction device can be extended with further vehicle data on account of the fact that the first and second data are jointly stored in the storage device of the portable multifunction device. The extended data records can be transmitted to a remote server and are available there for a customer for analysis.

As soon as the driver leaves the vehicle and breaks the connection between the vehicle unit and the portable multifunction device, vehicle data are no longer transmitted from the vehicle to the portable multifunction device. Data protection of personal data determined by the portable multifunction device can therefore be safeguarded.

The method makes it possible to couple a conventional portable multifunction device, in particular a smartphone, to the vehicle without additional expansions via an interface, in particular a radio interface. The multifunction device in the vehicle can therefore be used as a further sensor in addition to the sensors permanently installed in the vehicle. All data that are acquired or forwarded by the portable multifunction device can be enriched with the individual data relating to the vehicle, which can be read from the sensors in the vehicle via an air interface. There is therefore no need, for example, to permanently connect an on-board computer for position and lane recording to the vehicle. Instead, the portable multifunction device remains with the driver and can be converted, as it were, into a mobile vehicle locating and data transmission device by connecting it to the vehicle.

### BRIEF DESCRIPTION OF THE DRAWINGS

The invention is explained in more detail below using figures which show exemplary embodiments of the present invention and in which:

FIG. 1 shows an embodiment of a system for providing data associated with a vehicle;

FIG. 2 shows an embodiment of a portable multifunction device; and

FIG. 3 shows an embodiment of a method for providing data associated with a vehicle;

### DETAILED DESCRIPTION OF THE PRESENTLY PREFERRED EMBODIMENTS

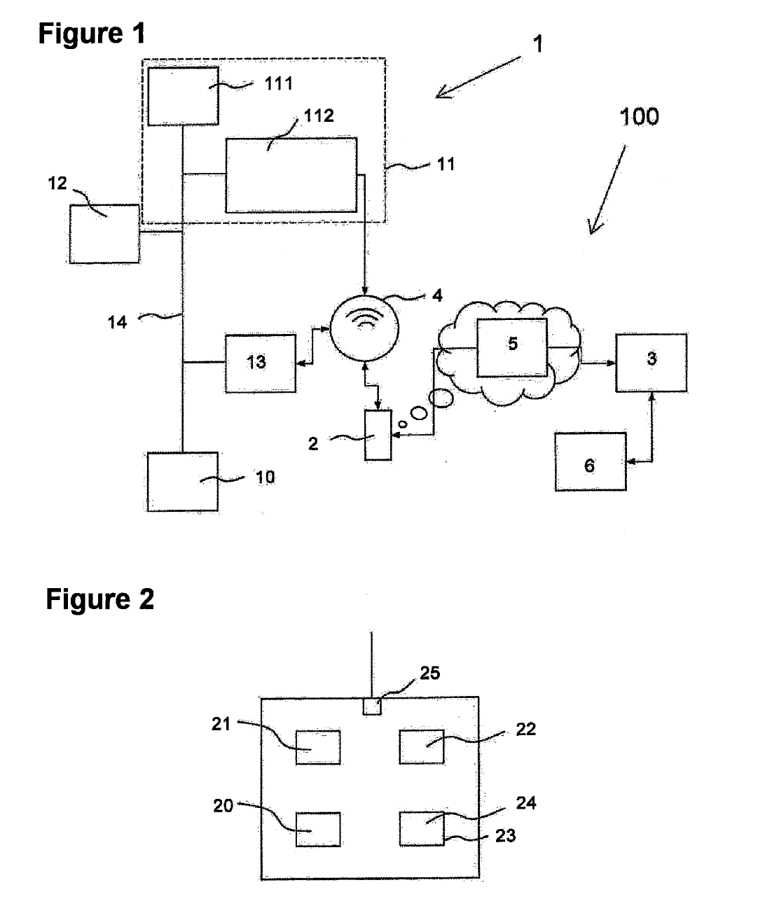

FIG. 1 shows a system 100 for providing data associated with a vehicle 1. The vehicle 1 comprises a vehicle unit 11 for determining first data for characterizing a state of the vehicle 1. The first data may be static or dynamic vehicle data. The data may characterize, for example, the technical state of the vehicle. The vehicle unit 11 may comprise a sensor device 111 for determining the first data. The sensor device 111 may contain a plurality of sensors, one of the sensors being able to record the oil temperature, for example, another sensor being able to record the state of charge of the battery and a further sensor being able to record the speeds of the vehicle. The vehicle unit 11 may also comprise a digital tachograph 112. The first data determined by the sensor device 111 or the digital tachograph 112 can be buffered in a storage device 12 of the vehicle 1. The vehicle 1 may also have an OBD connector 13 with a radio interface.

The vehicle 1 is configured such that the first data can be transmitted to a portable multifunction device 2. The portable multifunction device 2 may be directly connected to the digital tachograph 112 or to the OBD connector 13 via an air interface 4, for example. The vehicle 1 comprises a control device 10 for the purpose of controlling the determination of the first data, for storing the first data in the storage device 12 and for transmitting the first data from the vehicle 1 to the portable multifunction device 2. The control device 10, the vehicle unit 11 having the sensor device 111 and the digital tachograph 112 are connected via a bus 14, for example a CAN bus.

The portable multifunction device 2 may be in the form of a smartphone. The portable multifunction device 2 can determine second data, for example data that indicates a position of the multifunction device. The first data determined by the vehicle unit 11 can be read from the vehicle 1 and can be transmitted to the portable multifunction device 2. The first data and the second data are linked to one another and stored in the portable multifunction device 2, with the result that vehicle-related data or data linked to the vehicle can be provided in the portable multifunction device.

The vehicle data enriched with the second data can be transmitted from the portable multifunction device 2 to a remote data acquisition device 3 via a service provider 5, for example the Internet. A customer 6 can access the data acquisition device 3 and therefore gains an insight into the vehicle data extended with the second data.

The portable multifunction device 2 is configured such that the portable multifunction device 2 can determine whether the portable multifunction device 2 is connected to the vehicle 1. If the portable multifunction device 2 determines that there is no longer any connection to the vehicle 1, the storage of the first data in the portable multifunction device 2 is ended. The transmission of the first and second data to the data acquisition device 3 is also ended. This ensures that data protection of personal data relating to the owner of the portable multifunction device is safeguarded.

FIG. 2 shows an embodiment of the portable multifunction device 2. The portable multifunction device 2 may have a processor 20, which controls the determination of the second data, the storage of the first and second data and the transmission of the first and second data to the remote data acquisition device 3. The portable multifunction device 2 may comprise a sensor device 21 for determining the second data. The sensor device 21 may be in the form of a position determination device, which determines a position of the portable multifunction device by evaluating navigation signals, for example GPS signals. In this embodiment, the second data are position data. The portable multifunction device 2 may also comprise a storage device 22, which stores the first and second data. The portable multifunction device 2 may have a non-transitory computer-readable storage medium 23 for storing at least one program 24, for example for storing an app of a smartphone. The program 24 contains instructions for carrying out the method for providing the first and second data associated with the vehicle. The portable multifunction device has an interface device 25 for coupling the portable multifunction device to the vehicle 1 or to the data acquisition device 3.

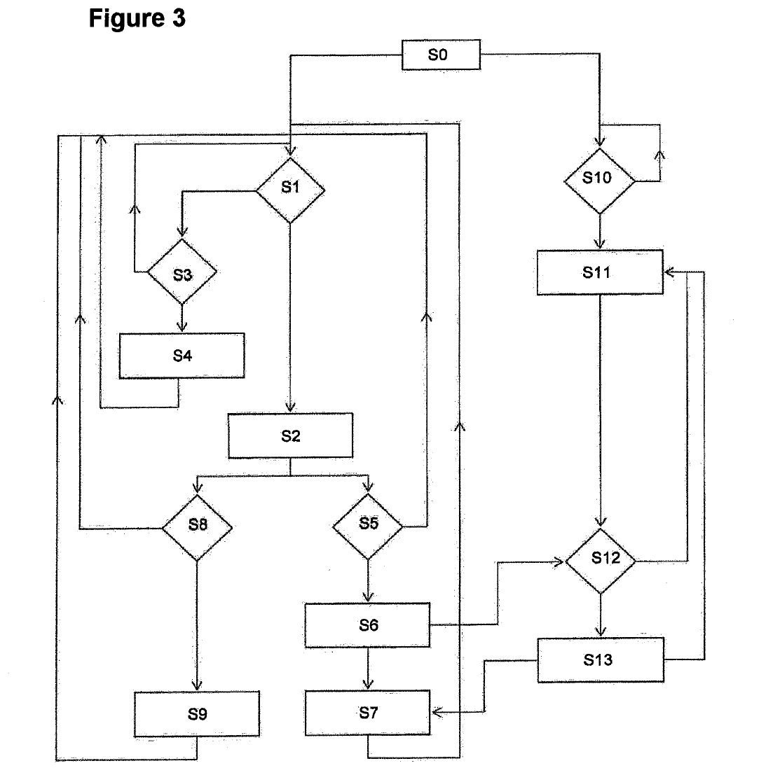

FIG. 3 is a flowchart showing a method sequence of a method for providing the first and second data associated with the vehicle 1. The method is started in a step S0. Method steps S1 to S9 subsequently indicated are controlled in the portable multifunction device, for example by the processor 20 of the portable multifunction device. Method steps S10 to S13 are carried out in the vehicle 1, for example by the control device 10.

In a method step S1, the portable multifunction device 2 checks whether the portable multifunction device is coupled to the vehicle 1. For example, a check is carried out in order to determine whether there is a connection to the vehicle unit 11. If it is determined that the portable multifunction device 2 is coupled to the vehicle 1, the second data are determined in the portable multifunction device 2 in a method step S2. The processor 20 may execute the program 24 for this purpose. The sensor device 21 of the portable multifunction device is used, for example, to determine positions of the portable multifunction device or of the vehicle if the portable multifunction device is in the vehicle. The determined position data may constitute the second data. They may be stored in the storage device 22 of the portable multifunction device.

If it is initially determined by the portable multifunction device 2 in method step S1 that there is no connection to the vehicle 1 or to the vehicle unit 11, the portable multifunction device 2 checks in a method step S3 whether a vehicle unit 11 is present. If the presence of the vehicle unit 11 has been determined, the portable multifunction device 2 is coupled to the vehicle 1 or to the vehicle unit 11 installed in the vehicle, for example via the air interface 4, in a method step S4. If it has been determined in method step S3 that no vehicle unit 11 is present, method step S1 is carried out again. Method step S1 is likewise carried out after the portable multifunction device has been coupled to the vehicle 1 in method step S4.

After the second data have been determined by the portable multifunction device, the portable multifunction device checks in a method step S5 whether a reading interval for reading the first data from the vehicle has been reached. The first data can be transmitted to the portable multifunction device 2 in a first interval of time. If it has been determined that the reading interval has been reached, the portable multifunction device 2 can transmit a request to transmit the first data to the vehicle in a method step S6. In a method step S7, the first data transmitted by the vehicle 1 on account of the request are received by the portable multifunction device 2 and can be stored in the storage device 22. If it has been determined in method step S5 that the reading interval has not yet been reached, method steps S1 and S2 are repeated.

In a method step S8, the portable multifunction device 2 checks whether a transmitting interval for transmitting the first and second data to the data acquisition device 3 has been reached. The first and second data can be transmitted to the data acquisition device 3 in a second interval of time. If the portable multifunction device 2 has determined that the transmitting interval has been reached, the first and second data stored in the portable multifunction device are transmitted to a server of the data acquisition device 3 in a method step S9. If it has been determined that the transmitting interval has not yet been reached, method steps S1 and S2 are repeated.

After the method has been started, it is determined in a method step S10 in the vehicle 1 whether the ignition of the vehicle has been switched on. If the switching-on of the ignition has been determined, the vehicle unit 11 determines first data, in particular by the sensor device 111, or generates first data, in particular by the digital tachograph 112, in a method step S11. The first data may be buffered in the storage device 12. In a method step S12, the control device 10 of the vehicle checks whether the portable multifunction device has made the request to transmit the first data. If it is determined that a request has not yet been transmitted, method step S11 is repeated. If, in contrast, it has been determined in method step S12 that a request is present, the first data collected in the vehicle 1 are transmitted to the portable multifunction device 2 in method step S13.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention.

Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-15. (canceled)

16. A method for providing data associated with a vehicle (1) having a vehicle unit (11), comprising:
the vehicle unit (11) determining first data that characterizes a state of the vehicle determining, by a sensor device (21) of a portable multifunction device (2), second data;
coupling the portable multifunction device (2) to the vehicle (1);
transmitting the first data to the portable multifunction device (2); and
storing the first and second data in the storage device (22) of the portable multifunction device (2).

17. The method as claimed in claim 16, further comprising:
reading the first and second data from the storage device (22) of the portable multifunction device (2); and
transmitting the read first and second data to a data acquisition device (3) spatially remote from the vehicle (1).

18. The method as claimed in claim 16, further comprising:
determining whether the portable multifunction device (2) is coupled to the vehicle (1); and
determining the second data using the sensor device (21) of the portable multifunction device (2) if it has been determined that the portable multifunction device (2) is coupled to the vehicle (1).

19. The method as claimed in claim 18, further comprising:
ending the storage of the first data in the portable multifunction device (2) and ending the transmission of the first and second data from the portable multifunction device (2) to the data acquisition device (3) if it has been determined that the portable multifunction device (2) is coupled to the vehicle (1).

20. The method as claimed in claim 16, further comprising:
transmitting a request to transmit the first data to the portable multifunction device (2) from the portable multifunction device to the vehicle (1);
the vehicle (1) checking the request; and
transmitting the first data from the vehicle (1) to the portable multifunction device (2) if it has been determined by the vehicle (1) that the portable multifunction device (2) has transmitted the request.

21. The method as claimed in claim 17, wherein
the first data is transmitted to the portable multifunction device (2) in a first interval of time, and
the first and second data are transmitted to the data acquisition device (3) in a second interval of time.

22. The method as claimed in claim 16, further comprising:
determining a position of the vehicle (1) by the sensor device (21) of the portable multifunction device (2); and
storing the second data, which characterizes the determined position of the vehicle, in the storage device (22) of the portable multifunction device (2).

23. The method as claimed in claim 16, wherein
the portable multifunction device (2) is coupled to the vehicle (1) by establishing a wireless connection between the vehicle (1) and the portable multifunction device (2).

24. The method as claimed in claim 16, wherein
the vehicle unit (10) has a sensor device (111) and/or a digital tachograph (112) configured to determine the first data, and
the first data is determined by the sensor device (111) and/or the digital tachograph (112).

25. The method as claimed in claim 24, wherein the portable multifunction device (2) is coupled to the vehicle (1) by establishing a connection between the digital tachograph (112) and the portable multifunction device (2) and/or by establishing a connection between an OBD connector (13) of the vehicle and the portable multifunction device (2).

26. The method as claimed in claim 16, wherein the portable multifunction device is a smartphone.

27. A non-transitory computer-readable storage medium (23) storing at least one program (24) comprising instructions to cause at least one program-controlled apparatus to carry out the method as claimed in claim 16.

28. A portable multifunction device, in particular a smartphone, comprising:
a processor (20);
a sensor device (21) configured to determine the second data;
a storage device (22) configured to store the first and second data;
a non-transitory computer-readable storage medium (23) as claimed in claim 27; and
an interface device (25) configured to couple the portable multifunction device to a vehicle (1),
wherein the processor (20) is configured to execute the program (24) stored in the non-transitory computer-readable storage medium (23).

29. A vehicle comprising:
a control device (10) configured to carry out the method as claimed in claim 16; and
a vehicle unit (11) configured to determine the first data, the vehicle unit (11) being coupleable to a portable multifunction device (2).

30. A system for providing data associated with a vehicle (1), comprising:
the vehicle (1);
a portable multifunction device (2) as claimed in claim 28; and
a data acquisition device (3) configured to store the first and second data, wherein the portable multifunction device is configured to transmit the first and second data stored in the storage device (22) of the portable multifunction device to the data acquisition device (3).
